(19) United States
(12) Patent Application Publication
(10) Pub. No.: US 2002/0053783 A1
(43) Pub. Date: May 9, 2002

(54) Cart coupling device

(76) Inventor: Terry Shannon Davis, Lilburn, GA (US)

Correspondence Address: Douglas M. Clarkson, 1720 Fireside Place, Alpharetta, GA, 30004, US

(21) Appl. No.: 10/004,160

(22) Filed: Nov. 2, 2001

Related U.S. Application Data
(60) Provisional application No. 60/245,152, filed on Nov. 3, 2000.

(51) Int. Cl. B60D 1/00

(52) U.S. Cl. 280/507; 280/504

(57) ABSTRACT

A coupling device that interconnects a plurality of carts by an extendable end on an elongated member that is movable from a retracted location beneath the cart. The coupling device includes a receiver end to secure with the extendable end of an another cart, but without it interfering with the fold up feature of the cart. The elongated member and the receiver end are part of two separate units that are mounted under a cart at opposite ends of the cart.

### REFERENCE

The information, data and all benefits of provisional application No. 60/245,152 filed Nov. 3, 2000 are incorporated by reference into this description.

The writing, the subject matter, and the description presented herein is protected under the provisions of United States Copyright laws by the inventor, except only to any extent required by law in order to obtain and to continue all patent protection that is available during the term of any patent that issues hereon.

### BACKGROUND OF THE INVENTION

1. Field of the Invention

The present invention, generally, relates to a coupling device for connecting at least two load-carrying carts permitting them to be moved in a train like manner and, more particularly, to a device that interconnects foldable carts for movement together.

While it is the custom to move packages of various weights and sizes on small carts, it is a recognized problem when more than two or three are connected for moving by a single prime mover that the carts will not follow each other. It is a real problem when carts are of the fold up type, because present coupling devices interfere with the folding operations when they are disconnected for storage.

### OBJECTS AND SUMMARY OF THE INVENTION

It is a principal object of the present invention to provide a coupling device that permits interconnecting any number of carts for movement together.

Another object of an arrangement according to the present invention is to provide a coupling device that retracts beneath the cart when not in use.

Briefly, an arrangement according to the present invention provides a coupling that interconnects a plurality of carts by an extendable end on an elongated member that is movable from a retracted location beneath the cart. The elongated member includes means to lock the extendable end in its extended position so that a push-pull connection can be made with another cart. The coupling device of the present invention also includes a receiver end to secure with the extendable end of an another cart, but without it interfering with the fold up feature of the cart.

The above and other objects, features and advantages of the present invention will become more readily apparent as the detailed description proceeds.

### BRIEF DESCRIPTION OF THE DRAWINGS

The presently preferred embodiment of the invention will be described, by way of example, with reference to the accompanying drawings, in which:

FIG. 1 is an isometric view from one end illustrating the coupling device of the present invention.

FIG. 2 is an isometric view from the opposite end of the coupling device of the invention as an aid in its description.

FIG. 3 is a plan view of the coupling device of the invention.

FIG. 4 is a side view of the coupling device of the invention.

### DETAILED DESCRIPTION OF THE INVENTION

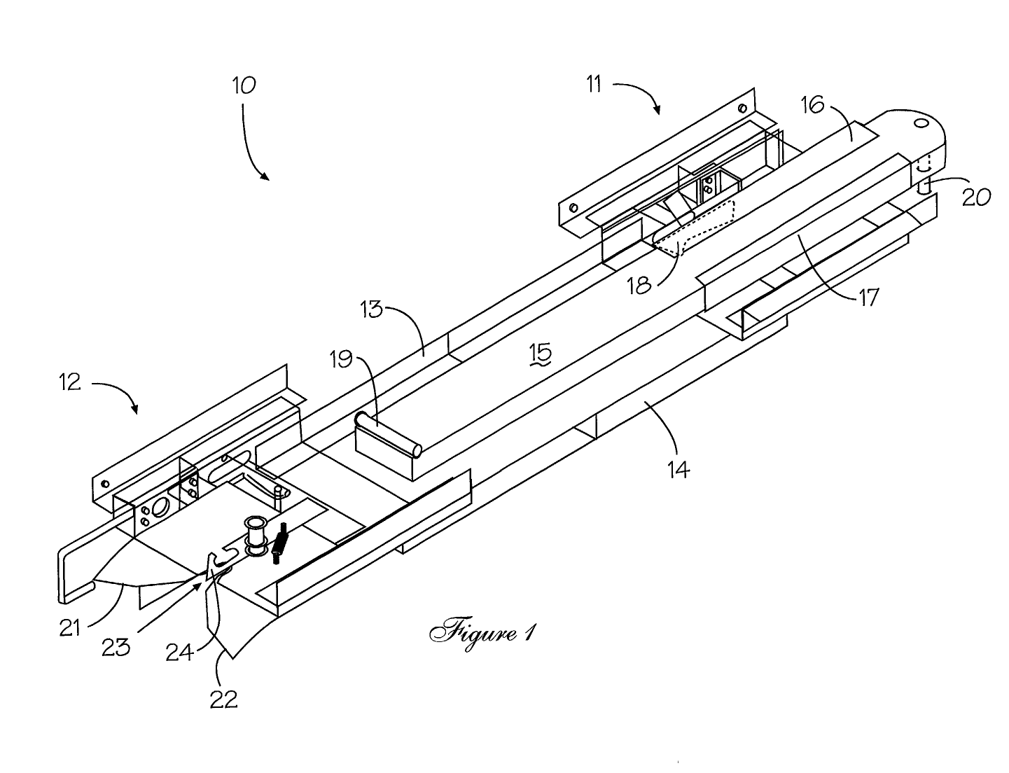

Referring first to FIG. 1 of the drawings, the structure of the overall coupling device of the present invention is identified by the numeral 10 . The coupling device 10 is to be attached to the under side of a four wheeled, load carrying cart (not shown) and, when not in use, the parts of the device 10 are retractable for storage under the cart, which permits a cart to be folded for storage and/or transporting.

Any number of four wheeled carts can be interconnected using the coupling illustrated. It has been found that the limit to the number of carts that can be moved in this manner is determined by the capability of a selected prime mover.

The overall coupling device 10 includes a first unit 11 and a second unit 12 that are interconnected by rigid beams 13 and 14, the purpose of which is to permit easy handling of the two units 11 and 12 as a single structure and to permit a proper alignment of the units with each other during installation under a cart.

An important advantage provided by the structural arrangement of the device 10 is realized when it is secured under a four wheel cart that is foldable, usually for storage, when not in use. It is customary that such carts be constructed for folding one end toward the other or even the two sides foldable toward the center.

The first unit 11 has an extendable member 15 that is slidable and guided between two steel guides 16 and 17 between a fully retracted location to an extended position (as illustrated), where a spring tensioned hook 18 engages a rod 19. Thus, the extendable member 15 is locked firmly in an extended, push-pull position. Of course, any type of locking arrangement that meets the purpose that will be described hereinafter is sufficient.

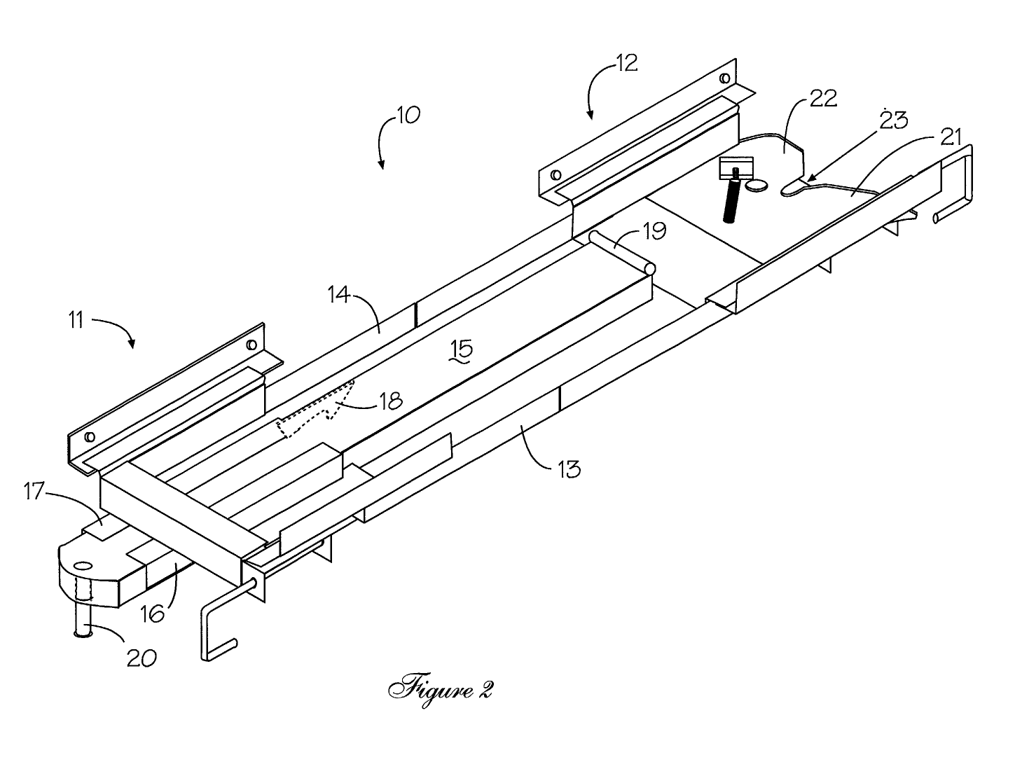

The second unit 12 is seen better in FIG. 2 of the drawings, where downwardly sloping edges 21 and 22 will guide a pin 20, on another cart, into a grove 23, where a spring tensioned hook 24 engages and locks with the pin 20. In a presently preferred embodiment, the extendable member 15 is hollow to reduce weight and also to permit support of the pin 20 in two spaced apart points along a portion of its total length.

Also, a handle 25 releases the spring tensioned hook 24, to permit separation of carts. In addition, a handle 26 releases the spring tensioned hook 18 so that the member 15 can return to its retracted location beneath the cart. A light pressure on each of these handles 25 and 26 releases the hooks 24 and 18, respectively.

The specific structure relating to the spring tensioned hooks 24 and 18 is not included simply because it is believed to confuse the important aspects of the coupling device of the invention. By this is meant that any arrangement that will accomplish the locking purpose is entirely satisfactory.

Significant features of the present invention do not include a specific lock arrangement.

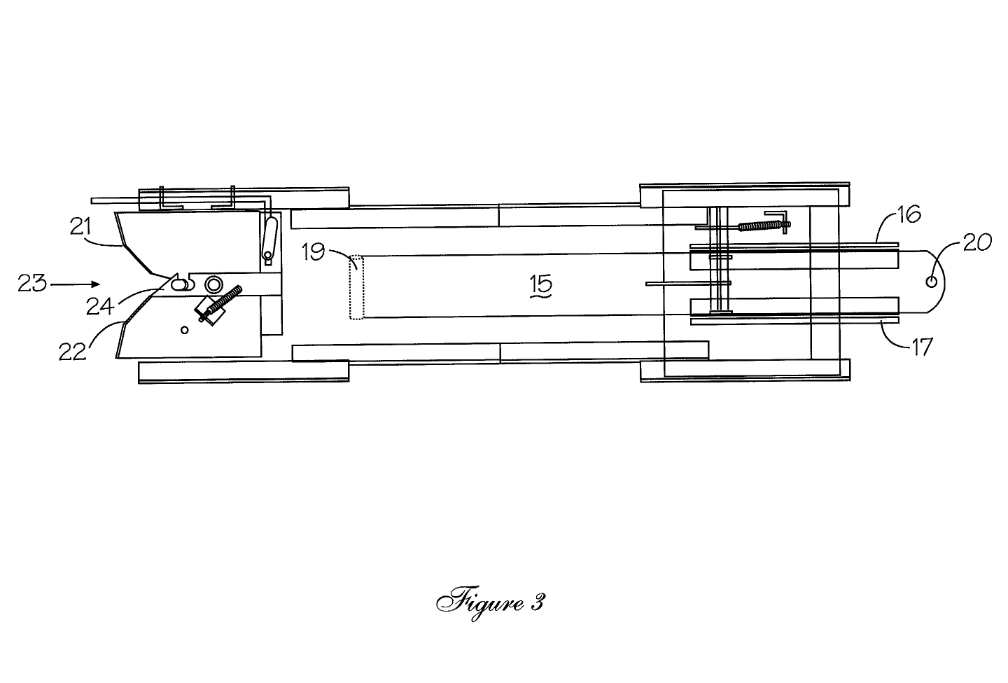

Now, in FIG. 3 of the drawings, the sloping edges 21 and 22 can be seen better, as well as the hook 24, which engages a pin 20 on another cart as that pin is guided by these sloping edges into the grove 23. These edges 21 and 22 are curved slightly down to provide greater assurance that the grove 23 will capture the pin 20 on another cart.

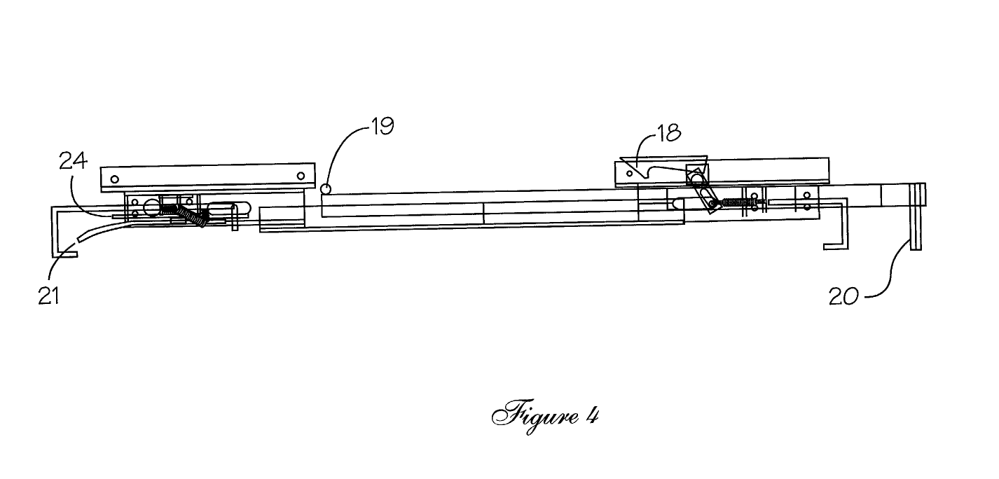

In FIG. 4, the spring tensioned hook 18 is seen, as well in a position to engage the rod 19, locking the member 15 in an extended position. Also shown here is the handle 26 which releases the hook 18 permitting the member 15 to be returned to a retracted location under the cart to which it is attached.

Certain details of practical implementations are omitted here, with the understanding that these are well known to the art. These details include the spring tensioned hooks 18 and 24 details of the connections between these hooks and the handles 25 and 26.

Otherwise, the invention has been described in substantial detail. It is understood that the invention is not limited by the description, but rather, the invention is intended to include any modification and any arrangement that is covered by the spirit and scope of the appended claims.

What is claimed is:

1. A device for connecting a plurality of carts to permit moving together, said device comprising:
two units attachable firmly at opposite ends under a four wheel, loadable cart;
an elongated member slidable in spaced apart tracks, and lockable when extended, from a retracted location in one of said two units;
a pin extending vertically from said elongated member at its farthermost point when extended;
a second unit of said two units having an edge facing outwardly away from said one unit of said two units; and
said outwardly facing edge having two points spaced apart and sloping toward the center of said edge ending in a slot to receive a pin extending vertically from an elongated member of a like device under another cart;
whereby said device can interconnect a plurality of carts for moving by a single prime mover, and said device will not interfere, when disconnected for storage or transporting for use at another location.

2. A device for connecting a plurality of carts to permit moving together as defined by claim 1 wherein said elongated member is rectangular in cross-section to resist deforming in use.

3. A device for connecting a plurality of carts to permit moving together as defined by claim 2 wherein said deforming that is resisted is a twisting.

4. A device for connecting a plurality of carts to permit moving together as defined by claim 2 wherein said elongated member is hollow to reduce weight.

5. A device for connecting a plurality of carts to permit moving together as defined by claim 1 wherein said elongated member being lockable when extended includes means to affect its release, so that said elongated member is readily retractable.

6. A device for connecting a plurality of four wheel carts for moving together by a single prime mover in a train like manner, said device comprising:
two units attachable firmly at opposite ends under a four wheel cart;
an elongated member slidable in spaced apart tracks, and lockable when extended from a retracted location in one of said two units;
a pin extending vertically from said elongated member at its farthermost point when extended;
said elongated member is rectangular in cross-section to resist deforming in use, and is hollow to reduce its weight;
a second unit of said two units having an edge facing outwardly away from said one unit; and
said outwardly facing edge having two points spaced apart and sloping toward the center of said edge ending in a slot to receive a pin extending vertically from an elongated member of a like device under another cart;
whereby said device can interconnect a plurality of carts for moving by a single prime mover, and said device will not interfere, when disconnected for storage or transporting for use at another location.

7. A device for connecting a plurality of carts to permit moving together as defined by claim 6 wherein said elongated member, being lockable when extended, includes means to affect its release, so that said elongated member is readily retractable.

8. A device for connecting a plurality of carts to permit moving together as defined by claim 6 wherein said deforming that is resisted is a twisting.

9. A device for connecting a plurality of carts to permit moving together as defined by claim 6 wherein said pin extending vertically is affixed to both surfaces within said hollow elongated member before exiting to extend downwardly .

10. A device for connecting a plurality of carts to permit moving together as defined by claim 6 wherein said hollow elongated member has an upper and a lower surface in said hollow member and said pin extending vertically is affixed to said upper surface within said elongated member, and is affixed to said lower surface before exiting to extend downwardly therefrom.
